(19) United States
(12) Patent Application Publication
(10) Pub. No.: US 2019/0359750 A1
(43) Pub. Date: Nov. 28, 2019

(54) PARTIALLY FLUORINATED COPOLYMERS DERIVED FROM FLUORINATED ALLYL ETHERS

(71) Applicant: 3M INNOVATIVE PROPERTIES COMPANY, St Paul, MN (US)

(72) Inventors: Yu Yang, Eden Prairie, MN (US); Klaus Hintzer, Kastl (DE); Zhipeng Song, West Chester, PA (US); Zhongxing Zhang, Woodbury, MN (US); Dong-Wei Zhu, North Oaks, MN (US)

(21) Appl. No.: 16/469,778

(22) PCT Filed: Dec. 12, 2017
(86) PCT No.: PCT/US2017/065666

§ 371 Date: Jun. 14, 2019

Related U.S. Application Data
(60) Provisional application No. 62/436,489, filed on Dec. 20, 2016.

(51) Int. Cl. C08F 216/14; C08F 218/04; C08F 230/02; C08F 230/08

(52) U.S. Cl. CPC C08F 216/1408; C08F 216/1416; C08F 230/08; C08F 230/02; C08F 218/04

(57) ABSTRACT

Described herein is a partially fluorinated copolymer of the formula: (I); wherein R¹ is selected from F or a fluorinated methyl; R² is selected from H, F, a methyl, or a (per)fluorinated methyl; R3? is a linear or branched fluorinated alkyl group comprising 1 to 12 carbon atoms, optionally with at least one catenated oxygen atom; p is 0, 1, or 2; r is 0 or 1; and Q comprises at least one of an hydroxide, a nitrile, an ester, a silane, a siloxane, a phosphoric acid or salt thereof, a sulphuric acid or salt thereof, an alkyl, an aryl, and combinations thereof; n is an integer of at least 2; and m is an integer of at least 2.

### TECHNICAL FIELD

A partially fluorinated copolymer is disclosed, wherein the fluorinated copolymer is derived from a fluorinated allyl ether monomer and monomer comprising a hydroxide, a nitrile, an ester, a silane, a siloxane, a phosphoric acid or salt thereof, a sulphuric acid or salt thereof, an aryl, or combinations thereof.

### SUMMARY

Carbon and fluorine form a strong bond that has a high dissociation energy. This high dissociation energy results in the inertness of perfluorinated compounds. However, due to its inertness, perfluorinated compounds are not readily miscible or soluble with non-perfluorinated compounds. Therefore, carbon-hydrogen bonds are incorporated into the compound to achieve compounds that are compatible with non-fluorinated material, yet have improved thermal, oxidative and/or chemical stability. Thus, there is a desire to identify novel partially fluorinated polymeric compounds. Such compounds may be useful, for example, in coatings, adhesive, seals, and gaskets.

In one aspect, a fluorinated copolymer is described. The fluorinated copolymer is of the formula:

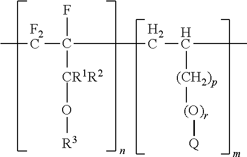

wherein R¹ is selected from F or a fluorinated methyl; R² is selected from H, F, a methyl, or a fluorinated methyl; R³ is a linear or branched fluorinated alkyl group comprising 1 to 12 carbon atoms, optionally with at least one catenated oxygen atom; p is 0, 1, or 2; r is 0 or 1; and Q comprises an hydroxide, a nitrile, an ester, a silane, a siloxane, a phosphoric acid or salt thereof, a sulphuric acid or salt thereof, an alkyl, an aryl, and combinations thereof; n is an integer of at least 2; and m is an integer of at least 2.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term

“a”, “an”, and “the” are used interchangeably and mean one or more; and

“and/or” is used to indicate one or both stated cases may occur, for example A and/or B includes, (A and B) and (A or B);

“copolymer” refers to a polymer derived from two or more different monomers and includes terpolymers, quadpolymers, etc.;

“crosslinking” refers to connecting two pre-formed polymer chains using chemical bonds or chemical groups in order to increase the modulus of the material;

“interpolymerized” refers to monomers that are polymerized together to form the backbone of a polymer;

“(meth)acrylate” refers to compounds containing either an acrylate (CH₂═CHCOOR) or a methacrylate (CH₂═CCH₃COOR) structure or combinations thereof;

“monomer” is a molecule which can undergo polymerization which then form part of the essential structure of a polymer;

“partially fluorinated” refers to a group or a compound comprising at least one carbon hydrogen bond and at least one carbon fluorine bond;

“perfluorinated” refers to a group or a compound derived from a hydrocarbon wherein all hydrogen atoms have been replaced by fluorine atoms. A perfluorinated compound may however still contain other atoms than fluorine and carbon atoms, like oxygen atoms, nitrogen atoms, sulfur atoms, chlorine atoms, bromine atoms and iodine atoms.

The term “polymer” as used herein refers to a molecule comprising a chain having at least four interpolymerized monomeric units.

The term “alkyl” refers to a monovalent group that is a radical of an alkane, which is a saturated hydrocarbon. The alkyl can be linear, branched, cyclic, or combinations thereof and typically has 1 to 50 carbon atoms. In some embodiments, the alkyl group contains at least 1, 2, 3, 4, 5, 6, 8, or 10 carbon atoms; at most 50, 40, 30, 28, 26, 25, 20, or 15 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “alkylene” refers to a divalent group that is a radical of an alkane. The alkylene can be straight-chained, branched, cyclic, or combinations thereof. The alkylene often has 1 to 50 carbon atoms. In some embodiments, the alkylene group contains at least 1, 2, 3, 4, 5, 6, 8, 10, 15, 20, or 25 carbon atoms; at most 50, 40, 30, 28, 26, 25, 20, 15, 10, 8, 6, 5, 4, or 3 carbon atoms. The radical centers of the alkylene can be on the same carbon atom (i.e., an alkylidene) or on different carbon atoms.

The term “arylene” refers to a divalent group that is a radical of an arene that has typically, 4, 5, or 6 carbon atoms.

The term “aryl alkylene” refers to a divalent group that comprises both an aromatic group and an alkane group. The aryl alkylene can be an aryl alkylene, that is, an alkylene substituted with an aryl, or alkarylene, that is, an arylene substituted with an alkyl. The aryl alkylene can have one to five rings that are connected to or fused to the aromatic ring and can comprise linear, branched, or cyclic segments, or combinations thereof. The aryl alkylene group typically has 4 to 30 carbon atoms. In some embodiments, the aryl alkylene group contains at least 4, 5, 6, 8, 10, 15, 20, or 25 carbon atoms; at most 50, 40, 30, 28, 26, 25, 20, 15, or 10 carbon atoms.

The term “aryl” refers to a monovalent group that is aromatic and carbocyclic or heterocyclic. The aryl can have one to five rings that are connected to or fused to the aromatic ring. The other ring structures can be aromatic, non-aromatic, or combinations thereof and typically has 3 to 30 carbon atoms. In some embodiments, the aryl group contains at least 3, 4, 5, 6, or 8 carbon atoms; at most 30, 28, 26, 25, 20, 15, or 10 carbon atoms. Examples of aryl groups include, but are not limited to, phenyl, biphenyl, terphenyl, anthryl, naphthyl, acenaphthyl, anthraquinonyl, phenanthryl, anthracenyl, pyrenyl, perylenyl, and fluorenyl.

The term “alkylaryl” refers to a monovalent group that is a combination of an alkyl and an aryl group. The alkylaryl can be an aralkyl, that is, an alkyl substituted with an aryl, or alkaryl, that is, an aryl substituted with an alkyl. The alkylaryl can have one to five rings that are connected to or fused to the aromatic ring and can comprise linear, branched, or cyclic segments, or combinations thereof. The alkylaryl group typically has 4 to 30 carbon atoms. In some embodiments, the alkylaryl group contains at least 4, 5, 6, 8, 10, 15, 20, or 25 carbon atoms; at most 50, 40, 30, 28, 26, 25, 20, 15, or 10 carbon atoms.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

The present disclosure is directed toward fluorinated copolymers derived from fluorinated allyl ethers. The fluorinated copolymers are of the formula:

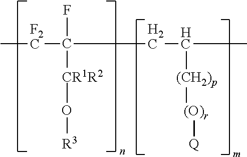

wherein R¹ is selected from F or a fluorinated methyl; R² is selected from H, F, a methyl, or a fluorinated methyl; R³ is a linear or branched fluorinated alkyl group comprising 1 to 12 carbon atoms, optionally with at least one catenated oxygen atom; p is 0, 1, or 2; r is 0 or 1; and Q comprises an hydroxide, a nitrile, an ester, a silane, a siloxane, a phosphoric acid or salt thereof, a sulfuric acid or salt thereof, an alkyl, an aryl, and combinations thereof; n is an integer of at least 2; and m is an integer of at least 2.

In one embodiment, R¹ and R² are both F.

R³ can comprise at least 1, 2, or 3 carbon atoms and at most 6, 8, 10, or even 12 carbon atoms. R³ may be perfluorinated or partially fluorinated. In one embodiment, R³ comprises 1, 2, or even 3 catenated oxygen atoms, for example R³ is —(CF₂)ₐ—O—(CF₂)_{b}CF₃ where a is an integer from 1-5 and b is an integer from 0-5. Exemplary R³ groups include: —C₃F₇, —(CF₂)₂—O—CF₃, —(CF₂)₃—O—CF₃, —CF₂CF(CF₃)OC₃F₇, CF₂CF₂—O—CF₃, —(CF₂)₃—O—CF₃, and —(CF₂)₂—O—CF₂—O—CH₃.

In one embodiment, Q comprises a hydroxyl (—OH) group. In one embodiment, Q is a hydroxy hydrocarbon comprising 1, 2, 3, 4, 5, 6, 7, 8, 9, or 10 carbon atoms, which can be a saturated linear or branched group, or cyclic in nature. Such Q groups include: —C₆H₄OH, and —(CH₂)_{c}OH, where c is an integer from 1-10.

In one embodiment, Q comprises a nitrile (—CN) group. In one embodiment, Q comprises a nitrile-containing hydrocarbon comprising 1, 2, 3, 4, 5, 6, 7, 8, 9, or 10 carbon atoms, which can be linear, branched, or cyclic. Such Q groups include: —C₆H₄CN, and —(CH₂)₄CN.

In one embodiment, Q comprises an ester (—C(═O)O—) group. In one embodiment, Q comprises an ester-containing hydrocarbon comprising 1, 2, 3, 4, 5, 6, 7, 8, 9, or 10 carbon atoms, which can be linear, branched, or cyclic. Such a Q group includes —C(═O)OCH₃.

In one embodiment, Q comprises a silane group. Such a Q group includes —Si(CH₃)ₙ(OCH₃)₃₋ₙ wherein n is an integer from 1-3, including —Si(CH₃)₃.

In one embodiment, Q comprises a siloxane group. Such a Q group includes —Si(R1)(R2)—O—Si(R3)(R4)(R5), where R1, R2, R3, R4, and R5 are independently selected from alkyl, aryl, or alkylaryl groups.

In one embodiment, Q comprises a phosphoric acid or a salt thereof. In one embodiment, Q is a hydrocarbon comprising a phosphoric acid group, or salt thereof containing 1, 2, 3, 4, 5, 6, 7, 8, 9, or 10 carbon atoms, which can be linear, branched, or cyclic. Such a Q group includes: —R—(PO₄)⁻²M wherein R is an alkylene, arylene or aryl alkylene, and M is a cation. M may comprise H⁺; inorganic cations including, but not limited to: Na⁺, Li⁺, Cs⁺, Ca⁺², K⁺, NH₄⁺, Mg⁺², Zn⁺², and Cu⁺²; and/or organic cations including, but not limited to N(CH₃)₄⁺, NH₂(CH₃)₂⁺, N(CH₂CH₃)₄⁺, NH(CH₂CH₃)₃⁺, NH(CH₃)₃⁺, and ((CH₃CH₂CH₂CH₂)₄)P⁺.

In one embodiment, Q comprises phosphonic acid or a salt thereof. In one embodiment, Q is a hydrocarbon comprising a phosphonic acid group, or salt thereof containing 1, 2, 3, 4, 5, 6, 7, 8, 9, or 10 carbon atoms, which can be linear, branched, or cyclic. Such a Q group includes: —R—(PO₃)⁻²M wherein R is an alkylene, arylene or aryl alkylene, and M is a cation as described above.

In one embodiment, Q comprises a sulfuric acid or a salt thereof. In one embodiment, Q is a hydrocarbon comprising a sulfuric acid group, or salt thereof containing 1, 2, 3, 4, 5, 6, 7, 8, 9, or 10 carbon atoms, which can be linear, branched, or cyclic. Such a Q group includes: —R—(SO₄)⁻M where R is an alkylene, arylene or aryl alkylene, and M is a cation as described above.

In one embodiment, Q comprises an alkyl group, having at least 1, 2, 3, 4, or even 6 carbon atoms and at most 10, 12, 14, or even 16 carbon atoms. Such Q groups include: —CH3, C₂H₅ and C₃H₇.

In one embodiment, Q comprises an aryl group, having 3, 4, 5, 6, 7, 8, 9, or 10 carbon atoms. Such a Q group includes: —C₆H₅.

In one embodiment, Q is —C(═O)R wherein R is a linear, cyclic, or branched alkyl group comprising 1 to 10 carbon atoms optionally comprising at least one of a nitrile moiety, a hydroxide moiety, and an aryl group comprising 3, 4, 5, 6, 7, 8, 9, or 10 carbon atoms. In one embodiment, the —C(═O)R is present with an ether oxygen from (O)ᵣ in Formula (I) to form —O—C(═O)R. Exemplary Q groups include —C(═O)C₆H₅, —C(═O)CH₃, and —C(═O)H. Exemplary monomers including such groups include vinyl esters such as vinyl acetate, and those commercially available under the trade designations “VEOVA-EH”, “VEOVA 9” and “VEOVA 10” from Momentive Specialty Chemicals Inc., Columbus, Ohio.

It is noted that the n and m integers represent the number of times the polymerized unit is repeated in the polymer structure. Although written sequentially, the monomeric units may be block polymerized or randomly polymerized together, wherein the integers n and m represent the number of times the monomeric unit appears in the polymer.

In one embodiment, wherein the polymer further comprising segment —[X]ₚ— wherein X comprises a pendent group and the pendent group comprises a siloxane moiety, a phosphoric acid or salt thereof, a phosphonic acid or salt thereof, a sulfuric acid or salt thereof, and combinations thereof. Such additional segments are introduced via the polymerization of monomers comprising such pendent groups. Such groups may be added to adjust the hydrophobic and hydrophilic properties of the resulting polymer.

The copolymers of the present disclosure can be prepared by polymerizing a fluorinated allyl ether monomer in the presence of a second monomer having a pendent group comprising an hydroxide, a nitrile, an ester, a silane, a siloxane, a phosphoric acid or salt thereof, a sulphuric acid or salt thereof, an aryl, or combinations thereof.

In one embodiment, the fluorinated allyl ether monomers are selected from CF₂═CFCF₂—O—RF, CF₂═CFCF₂[—O—CF(CF₃)—CF₂]_{z}—O—RF; and CF₂═CFCF₂[O—(CF₂)ₐ-]_{b}O-R_{F}, where R_{F} is CF₃, C₂F₅, or C₃F₇, z is an integer from 1-3, a is an integer from 1, 2, 3, 4, 5, or 6, and b is an integer from 1, 2, 3, or 4. Exemplary fluorinated allyl ether monomers include: CF₂═CF—CF₂—O—C₃F₇; CF₂═CF—CF₂—O—(CF₂)₂—O—CF₃; CF₂═CF—CF₂—O—(CF₂)₃—O—CF₃ and CF₂═CF—CF₂—O—CF₂—CF₂—O—C(—OCH₃)F₂.

In one embodiment the second monomers are selected from: CH₂═CH—OC(═O)R where R is CH₃, C₂H₅, C₃H₇ or C(CH₃)R′R² where R¹ and R² independently represent an alkyl group having at least one carbon atom; CH₂═CH—CH₂—OC(═O)R where R is CH₃, C₂H₅, or C₃H₇ or C(CH₃)R¹R² where R¹ and R² independently represent an alkyl group having at least one carbon atom.

Exemplary polymers include:

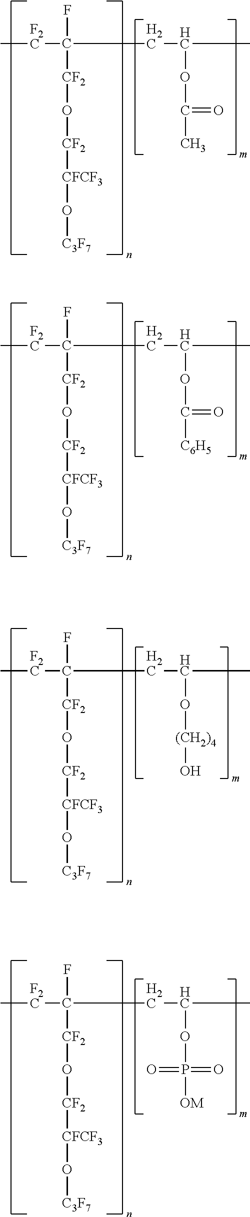

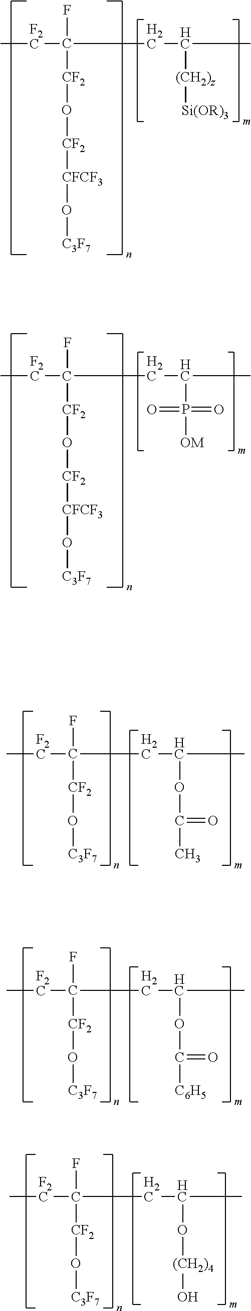

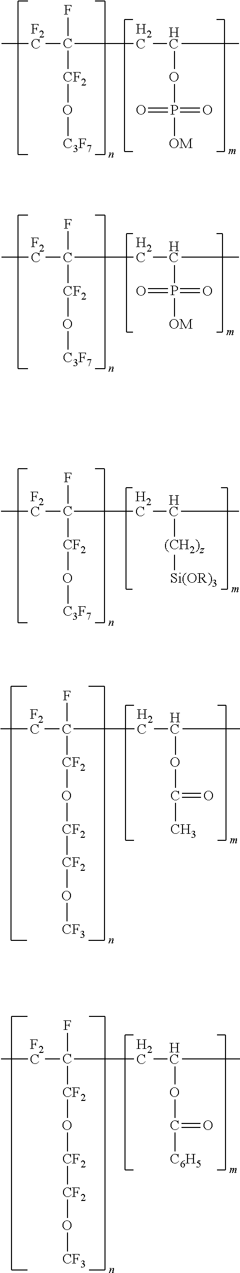

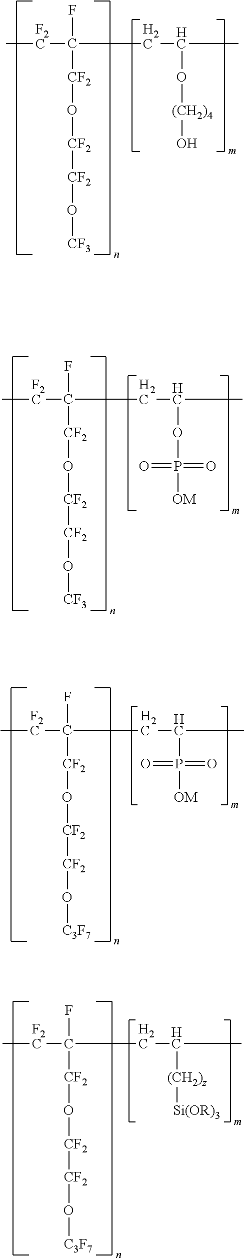

wherein M is a cation (as described above) and R is an alkyl group, which may be linear or branched.

It is preferred that the mole ratio of the fluorinated allylether and the second monomer is in the range of from 10:1 to 1:10, preferably in the range of 1:1 to 1:5, or even 1:1 to 1:2.

In one embodiment, the fluorinated copolymer may comprise additional monomeric units randomly polymerized into the fluorinated copolymer. These additional monomeric units may be incorporated into the fluorinated copolymer to modify its properties, such as improve adhesion to various substrates. These additional monomers, if present, are no more then 20, 15, 10, 5 or even 3% by weight based on the total weight of the polymer.

Exemplary additional monomers include: hydrocarbon (meth)acrylates such as polyalkyleneoxy (meth)acrylate, cyclohexyl (meth)acrylate, methyl methacrylate, and isobornyl (meth)acrylate; (meth)acryloyl-containing monomers such as acryloyl benzophenone and para-acryloxyethoxybenzophenone; hydroxyl-containing monomers such as a reaction product of acrylic acid and a glycidyl ester of versatic acid commercially available under the trade designation “ACE HYDROXYLACRYLATE MONOMER” from Hexion Specialty Chemicals, Belgium, 4-hydroxybutyl acrylate commercially available from BASF AG, Germany and 2-hydroxy-3-phenoxypropyl acrylate from Shin Nakamura, Japan; carboxyl-containing monomers such as itaconic acid, fumaric acid, crotonic acid, citraconic acid, and maleic acid, □-carboxyethylacrylate; and nitrogen-containing monomers such as amine functional and amide functional monomers, such as N,N-dialkylaminoalkyl (meth)acrylates, N,N-dialkyl(meth)acrylamide, N-vinyl-2-pyrrolidone, N-vinyl caprolactam, and acrylonitrile; and combinations thereof.

In addition, additional monomers may be polymerized into the copolymer. For example non-fluorinated olefinic monomers can be used such as propylene, ethylene, isobutylene, and combinations thereof. For example, cure site monomers can be used to incorporate cure sites into the copolymer enabling subsequent crosslinking of the copolymer. Such cure sites are known in the art and include, halogenated cure site monomers, nitrile-containing cure site monomers, hydroxy-containing cure site monomers, acid- or ester-containing cure site, olefinic cure site monomers, amine and azide cure site monomers, and the like.

Exemplary halogenated cure site monomers may be represented by one or more compounds of the formula: CX₂═CX(Z), wherein: (i) X each is independently H or F; and (ii) Z is I, Br, R_{f}—U wherein U=I or Br and R_{f}=a perfluorinated or partially perfluorinated alkylene group optionally containing catenated oxygen atoms. In addition, non-fluorinated bromo- or iodo-olefins, e.g., vinyl iodide and allyl iodide, can be used. In some embodiments, the cure site monomers are one or more compounds selected from the group consisting of CH₂═CHI, CF₂═CHI, CF₂═CFI, CH₂═CHCH₂I, CF₂═CFCF₂I, CH₂═CHCF₂CF₂I, CF₂═CFCH₂CH₂I, CF₂═CFCF₂CF₂I, CH₂═CH(CF₂)₆CH₂CH₂I, CF₂═CFOCF₂CF₂I, CF₂═CFOCF₂CF₂CF₂I, CF₂═CFOCF₂CF₂CH₂I, CF₂═CFCF₂OCH₂CH₂I, CF₂═CFO(CF₂)₃—OCF₂CF₂I, CH₂═CHBr, CF₂═CHBr, CF₂═CFBr, CH₂═CHCH₂Br, CF₂═CFCF₂Br, CH₂═CHCF₂CF₂Br, CF₂═CFOCF₂CF₂Br, CF₂═CFCl, CF₂═CFCF₂Cl, and a combination thereof.

Exemplary nitrile-containing cure site monomers include perfluoro(8-cyano-5-methyl-3,6-dioxa-1-octene); CF₂═CFO(CF₂)_{L}CN wherein L is an integer from 2 to 12; CF₂═CFO(CF₂)ᵤOCF(CF₃)CN wherein u is an integer from 2 to 6; CF₂═CFO[CF₂CF(CF₃)O]_{q}(CF₂O)_{y}CF(CF₃)CN wherein q is an integer from 0 to 4 and y is an integer from 0 to 6; or CF₂═CF[OCF₂CF(CF₃)]ᵣO(CF₂)ₜCN wherein r is 1 or 2, and t is an integer from 1 to 4; and derivatives and combinations of the foregoing.

Exemplary hydroxy-containing cure site monomers may be represented by the formula: CXX═CX(CXX)_{q}—(O)ₙ—(CXX)ₘ—(O)ₚ—(CHZ)ₛ—(CYY)ᵣ—CH₂OH wherein each X is independently selected from H or F; q is 0 or 1; n is 0 or 1; Z is either a OH, a C1-C5 alkyl group comprising a hydroxyl group, or a C1-C5 fluorinated alkyl group comprising a hydroxyl group; each Y is independently selected from H, F, an alkyl group, or a fluorinated alkyl group; m is an integer from 0-10; p is 0 or 1; s is an integer from 0-2; and r is an integer from 0-10. Exemplary fluorinated hydroxy-containing cure site monomers include: CF₂═CF—O—(CF₂)ₜ—CH₂OH and CF₂═CF—CF₂—O—(CF₂)ₜ—CH₂OH where t is an integer from 1-5. Exemplary nonfluorinated hydroxy-containing cure site monomers include: CH₂═CH—O—(CH₂)ᵥ—OH, CH₂═CH—CH₂—O—(CH₂)ᵥ—OH, and CH₂═CH—(CH₂)ᵥ—OH, where v is an integer from 1-6.

Exemplary acid- or ester-containing cure site monomers may be represented by the formula CXX═CX(CXX)_{q}—(O)ₙ—(CXY)ₘ—(O)ₚ—(CXQ)ₛ—(CYY)ᵣ-Q wherein each X is independently selected from H or F; each Y is independently selected from H, F, an alkyl group, or a fluorinated alkyl group; q is 0 or 1; n is 0 or 1; m is an integer from 0-10; p is 0 or 1; s is an integer from 0-2; r is an integer from 0-10; and Q is selected from COO⁻¹, COOR, wherein R is a linear or branched alkyl group comprising 1 to 5 carbons, an alkyl group comprising COO⁻¹, or COOR, or a fluorinated group alkyl group comprising —COO⁻¹, or —COOR as previously described. Exemplary monomers include CF₂═CF[O—CF(CF₃)CF₂]_{b}—O—(CF₂)_{c}-Q where b is 0 or 1 and c is an integer of 1-10; CF₂═CF—CF₂[O—CF(CF₃)CF₂]_{d}—O—(CF₂)_{c}-Q where d is an integer from 0-2 and c is an integer of 1-10; CH₂═CH—COOH; CH₂═CH—COOR where R is defined above; CH₂═CH—O—(CH₂)_{c}—COOH where c is defined above; CH₂═CH—O—(CH₂)_{c}—COOR where c and R are defined above; CH₂═CH—CH₂—O—(CH₂)_{c}—COOH where c is defined above; CH₂═CH—CH₂—O—(CH₂)_{c}—COOR where c and R are defined above; and CH₂═CH—O—C₆H₄-Q where Q is defined above.

Exemplary olefinic cure site monomers may be represented by the formula: CXX═CX(CXX)_{q}—(O)ₙ—(CXY)ₘ—(O)ₚ—(CXX)ₛ—(CXX)ᵣ—CX═CXX wherein each X is independently selected from H or F; q is 0 or 1; n is 0 or 1; m is an integer from 0-10; p is 0 or 1; s is an integer from 0-2; and r is an integer from 0-10. Exemplary monomers include CF₂═CF—O—(CF₂)ₐ—O—CF═CF₂, CF₂═CF—CF₂—O—(CF₂)ₐ—O—CF₂—CF═CF₂, CF₂═CF—O—(CF₂)ₐ—CH═CH₂, CH₂═CH—(CF₂)ₐ—CH═CH₂, CF₂═CF—O—(CF₂)ₐ—O—CF₂—CF═CF₂, CH₂═CH—O—(CH₂)ₐ—CH═CH₂, and CH₂═CH—O—(CH₂)ₐ—O—CH═CH₂ where a is an integer from 1-10.

Exemplary amine and azide cure site monomers may be represented by the formula CXX═CX(CXX)_{q}—(O)ₙ—(CXY)ₘ—(O)ₚ—(CXZ′)ₚ—(CYY)ᵣ—Z′ wherein each X is independently selected from H or F; each Y is independently selected from H, F, an alkyl group, or a fluorinated alkyl group; q is 0 or 1; n is 0 or 1; m is an integer from 0-10; p is 0 or 1; s is an integer from 0-2; r is an integer from 0-10; and Z′ is selected from an amine or an azide. Exemplary monomers include: CH₂═CH—O—(CH₂)ₐ—NH₂, CH₂═CH—CH₂—O—(CH₂)ₐ—NH₂, CH₂═CH—(CH₂)ₐ—NH₂, CH₂═CH—O—C₆H₄—NH₂, CF₂═CF—O—(CF₂)ₐ—(CH₂)_{c}—NH₂, CF₂═CF—CF₂—O—(CF₂)ₐ—(CH₂)_{c}—NH₂, CF₂═CF₂—O—(CF—CF₂)_{b}—(CF₂)ₐ—(CH₂)_{c}—NH₂, CH₂═CH—O—(CH₂)ₐ—N₃, CH₂═CH—CH₂—O—(CH₂)ₐ—N₃, CH₂═CH—(CH₂)ₐ—N₃, CH₂═CH—O—C₆H₄—N₃, CF₂═CF—O—(CF₂)ₐ—N₃, CF₂═CF—O—(CF₂)ₐ—(CH₂)_{c}—N₃, CF₂═CF—CF₂—O—(CF₂)ₐ—N₃, CF₂═CF—CF₂—O—(CF₂)ₐ(CH₂)_{c}—N₃, and CF₂═CF—O—(CF(CF₃)—CF₂)_{b}—O—(CF₂)ₐ—(CH₂)_{d}—N₃, where a is an integer from 1-6, b is an integer from 0-2, c is an integer from 1-4, and d is an integer from 0-4.

The low molecular weight fluorinated polymer can be prepared by free radical initiated polymerization in solvent (e.g. tert-butanol, ethylacetate) or in aqueous suspension or emulsion.

Such free radical polymerizations are known in the art. By adjusting the concentration of the monomers, the concentration and activity of the initiator, the temperature, and the chain-transfer agent used, if any, the molecular weight of the low molecular weight fluorinated polymer can be controlled to form the polymer.

In one embodiment, the fluorinated copolymer of the present disclosure has low molecular weight, for example a number average molecular weight (Mn) of less than 100, 50, 25, 10, 5, 1, or even 0.5 kilograms/mole. In one embodiment, the fluorinated copolymer of the present disclosure has high molecular weight, for example a number average molecular weight (Mn) of at least 100, 200, or even 300 kilograms/mole; and at most 400, 500; 750; 1000; or even 1500 kilograms/mole.

In one embodiment, the fluorinated copolymer of the present disclosure has a Tg of less than 50, 40, 30, or even 10° C. In one embodiment, the fluorinated copolymer of the present disclosure has a Tg of at least −70, −60, or even −50° C.; and at most 0, −10, −20, or even −30° C.

The copolymers of the present disclosure may be used in a variety of applications, depending on, among other things, their molecular weight and Tg. Such applications include, tackifiers or plasticizers for adhesive compositions, coatings, additives, seals, gaskets, films, etc.

### EXAMPLES

All materials are commercially available, for example from Sigma-Aldrich Chemical Company, Milwaukee, Wis., USA, or known to those skilled in the art, unless otherwise stated or apparent.

The following abbreviations are used in this section: mL=milliliters, g=grams, kg=kilograms, min=minutes, h=hours. Abbreviations for materials used in this section, as well as descriptions of the materials, are provided in Table 1.

TABLE 1

| Material | Details |
|---|---|
| MA31 | CF2═CFCF2OCF2CF2CF2OCF3, can be prepared as described in |
| | Example 3 of UK Patent Application 2,459,672 |
| MA211 | CF2═CFCF2OCF2CF2OCF2OCF3, available from Anles, St. Petersburg, |
| | Russia |
| Vazo 67 | Available from Dupont Chemical Solutions Enterprise, Wilmington, DE, |
| | USA |
| EA | Ethyl acetate, available from Sigma-Aldrich Chemical Company |
| Vinyl Acetate | CH2═CHOCOCH3, available from Sigma-Aldrich Chemical Company |
| HBVE | CH2═CHO(CH2)4OH, available from Sigma-Aldrich Chemical Company |

Characterization Methods

TGA (Thermal Decomposition)

Thermogravimetric analysis was performed using a Q5000 IR TGA, available from TA Instruments, New Castle, Del., USA. The sample materials were heated in nitrogen from 50 to 550° C. at a ramp rate of 20° C./min, then switched to air and continued heating to 700° C. in order to clean the instrument between samples.

T_{g} from DSC

Differential scanning calorimetry (DSC) was performed using a Q2000 DSC, available from TA Instruments. The sample material was heated in standard aluminum DSC pans (non-hermetic). The sample material was measured using a heat/cool/heat cycle with a minimum temperature of −30° C. and a temperature rate of change of 20° C./min under nitrogen, dried with a drying column, flowing at 50 mL/min. The TGA results were used to select maximum temperatures for each sample measured.

### Examples 1 through 6 (EX-1 through EX-6)

Individual 1 oz (30 mL) glass jars were charged with 0.24 g Vazo67 and 15 g EA and other components in accordance with Table 2. The jars were purged with nitrogen, tightly sealed, and polymerized in a water bath at 65° C. for 20 h. Following polymerization, the contents of each jar were poured into an individual pan and dried at 100° C. The mass of the dried solid in each pan was determined and is reported in Table 2 as “Polymer Produced (g).” Yield was calculated as the ratio of the mass of the dry solid to the sum of the mass of the monomers; yield is reported in Table 2. Dried solid was collected from each pan for DSC and TGA analysis. The measured thermal decomposition onset and T_{g} temperatures determined by DSC and TGA for each polymer are reported in Table 2.

TABLE 2

| | | | | Vinyl | | Polymer | Thermal Decom- | |
|---|---|---|---|---|---|---|---|---|
| | Molar | MA31 | MA211 | Acetate | HBVE | produced | position Onset | Tg |
| Example | Ratio* | (g) | (g) | (g) | (g) | (g) (yield) | (° C.) | (° C.) |
| EX-1 | 1:1 | 11.46 | — | 2.58 | — | 6.8 (48%) | 338 | 13.2 |
| EX-2 | 1:2 | 11.46 | — | 5.16 | — | 11.7 (86%) | 344 | NM |
| EX-3 | 1:1 | — | 11.82 | 2.58 | — | 7 (49%) | 335 | −3.7 |
| EX-4 | 1:2 | — | 11.82 | 5.16 | — | 12 (71%) | 338 | 5.2 |
| EX-5 | 1:1 | 11.46 | — | — | 3.51 | 2.4 (16%) | 403 | 11.9 |
| EX-6 | 1:1 | — | 11.82 | — | 3.51 | 7 (46%) | 387 | 8.4 |

NM = A measurement was attempted but a transition was not observed.
*Molar Ratio refers to the molar ratio of fluorinated allyl ether to vinyl ester or vinyl ether.

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will control.

What is claimed is:

1. A polymer of the formula (I): 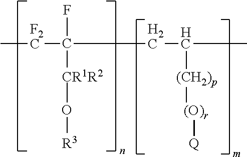
wherein R¹ is selected from F or a fluorinated methyl; R² is selected from H, F, a methyl, or a fluorinated methyl; R³ is a linear or branched fluorinated alkyl group comprising 1 to 12 carbon atoms, optionally with at least one catenated oxygen atom; p is 0, 1, or 2; r is 0 or 1; and Q comprises an hydroxide, a nitrile, an ester, a silane, a siloxane, a phosphoric acid or salt thereof, a sulphuric acid or salt thereof, an alkyl, an aryl, and combinations thereof; n is an integer of at least 2; and m is an integer of at least 2.

2. The polymer of claim 1, wherein r is 1 and Q is —C(═O)R wherein R is a linear, cyclic, or branched alkyl group comprising 1 to 10 carbon atoms optionally comprising a nitrile moiety, a hydroxide moiety, an ester moiety, an aryl group comprising 3 to 10 carbon atoms, and combinations thereof.

3. The polymer of claim 1, wherein Q comprises an alkyl nitrile wherein the alkyl nitrile comprises 1 to 10 carbon atoms.

4. The polymer of claim 1, wherein Q comprises an alkyl hydroxide wherein the alkyl hydroxide comprises 1 to 10 carbon atoms.

5. The polymer of claim 1, wherein Q is selected from: —C6H5, —C(═O)CH3, —C(═O)C6H5, —C6H4OH, and —(CH₂)cOH, where c is an integer from 1-10.

6. The polymer of any one of the previous claims, wherein R¹ and R² are both F.

7. The polymer of any one of the previous claims, wherein R³ is perfluorinated.

8. The polymer of any one of the previous claims, wherein R3 is —(CF₂)a-O—(CF₂)bCF3 where a is an integer from 1-5 and b is an integer from 0-5.

9. The polymer of any one of the previous claims, wherein the ratio of n to m is from 1:1 to 1:5.

10. The polymer of any one of the previous claims, wherein the polymer has a number average molecular weight of less than 100,000 g/mol.

11. The polymer of any one of the previous claims, wherein the polymer further comprising segment —[X]p- wherein X comprises a pendent group and the pendent group comprises a siloxane moiety, a phosphoric acid or salt thereof, a sulfuric acid or salt thereof, and combinations thereof.

12. The polymer of any one of the previous claims, wherein the polymer comprises: 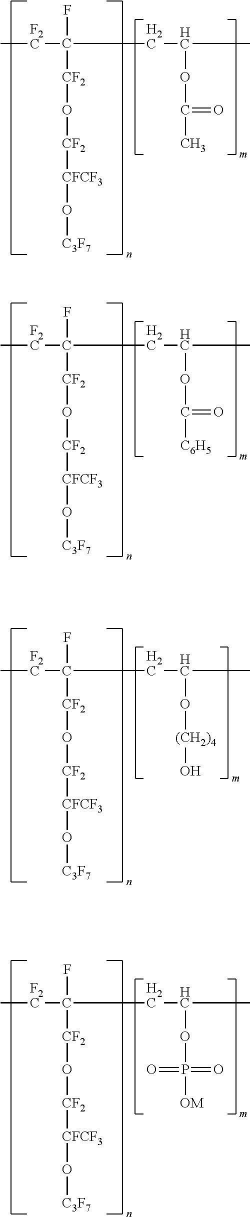 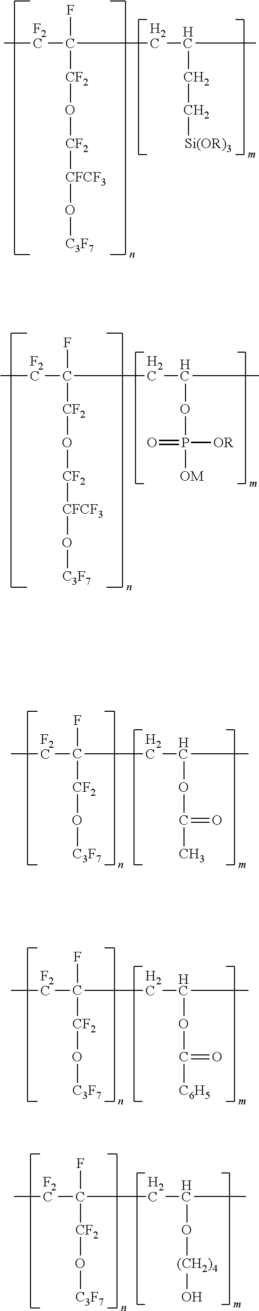 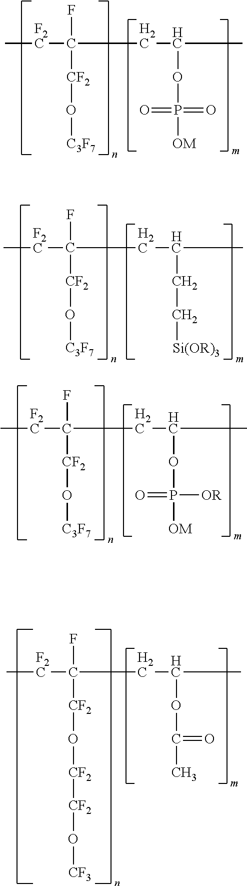 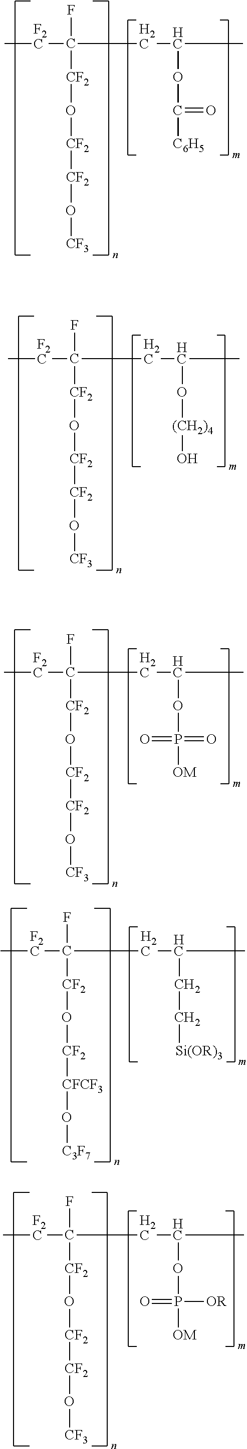
and combinations thereof, wherein M is a cation and R is an alkyl group.
